(19) United States
(12) Patent Application Publication
(10) Pub. No.: US 2019/0229576 A1
(43) Pub. Date: Jul. 25, 2019

(54) ROTARY ELECTRIC MACHINE AND STATOR

(71) Applicant: HONDA MOTOR CO., LTD., Tokyo (JP)

(72) Inventors: Kazuha Miura, Wako-shi (JP); Yoshiaki Hatano, Wako-shi (JP)

(21) Appl. No.: 16/253,316

(22) Filed: Jan. 22, 2019

(30) Foreign Application Priority Data
Jan. 25, 2018 (JP) 2018-010336

(51) Int. Cl. H02K 5/15; H02K 1/18

(52) U.S. Cl. CPC H02K 5/15; H02K 2205/12; H02K 2205/03; H02K 1/18

(57) ABSTRACT

A rotary electric machine includes a cylindrical stator core on which a coil is mounted, and a case to which the stator core is fastened via a fastening member. An insertion portion which penetrates the stator core in an axial direction of the stator core and through which the fastening member is inserted is formed in the stator core, a longitudinal direction of the insertion portion being along a radial direction of the stator core.

### CROSS-REFERENCE TO RELATED APPLICATION

Priority is claimed on Japanese Patent Application No. 2018-010336, filed in Japan on Jan. 25, 2018, the content of which is incorporated herein by reference.

### BACKGROUND OF THE INVENTION

### Field of the Invention

The present invention relates to a rotary electric machine and a stator.

### Description of Related Art

In a rotary electric machine, a magnetic field is formed in a stator core when a current is supplied to a coil, and thereby a magnetic attractive force or a repulsive force (electromagnetic excitation force) is generated between a permanent magnet of a rotor and the stator core.

Thereby, the rotor rotates with respect to the stator.

Incidentally, in the rotary electric machine described above, there is a likelihood of vibration in a circular zero-order mode (vibration in which a stator core expands and contracts in a concentric circular shape) occurring in the stator due to the electromagnetic excitation force described above. The vibration of the stator is transmitted to the surroundings through a case holding the stator. At this time, when the electromagnetic excitation force excites a resonance mode due to a structure of the case, there is a likelihood that it will become an unpleasant sound and be transmitted to a passenger compartment.

Therefore, for example, Japanese Unexamined Patent Application No. 2010-141946 discloses a configuration in which a stator core is divided into a plurality of blocks formed by stacking a plurality of electromagnetic steel sheets. In each of the blocks, a lug portion for fixing the stator core to the case is formed. The lug portions formed in the respective blocks are disposed with different phases between the respective blocks. Thereby it is said that overlap of antinodes of vibration between the respective blocks can be avoided, and vibration and noise of the rotary electric machine can be reduced.

### SUMMARY OF THE INVENTION

However, in the above-described conventional technology, it was necessary to set positions of lug portions to make fixed positions of the case and the stator core different between the respective blocks in an axial direction, or the like, thereby leading to a complicated configuration.

An aspect according to the present invention has been made in view of the above circumstances and an objective thereof is to provide a rotary electric machine and a stator in which generation of noise is suppressed in addition to achieving a simplified configuration.

In order to solve the above-described problem and achieve the objective, the present invention employs the following aspects.

(1) A rotary electric machine according to one aspect of the present invention includes a cylindrical stator core on which a coil is mounted, and a case to which the stator core is fastened via a fastening member, wherein an insertion portion which penetrates the stator core in an axial direction of the stator core and through which the fastening member is inserted is formed in the stator core, a longitudinal direction of the insertion portion being along a radial direction of the stator core.

(2) In the above-described aspect (1), an attachment hole to which the fastening member is fastened may be formed in the case, and a dowel which is disposed inside the insertion portion and the attachment hole and in which the fastening member is inserted may be provided.

(3) In the above-described aspect (1) or (2), the fastening member may be a bolt, and a receiver which supports an axial load and allows radial displacement of the stator core with respect to the fastening member and the case may be interposed in at least one of a space between a head portion of the fastening member and the stator core and a space between the stator core and the case in the axial direction.

(4) In the above-described aspect (3), the receiver may include a washer.

(5) In the above-described aspect (3) or (4), the receiver may include a thrust bearing.

(6) A stator according to one aspect of the present invention includes a cylindrical stator core on which a coil is mounted, wherein an insertion portion through which a fastening member that fastens the stator core to a case is formed in the stator core, and the insertion portion penetrates the stator core in an axial direction of the stator core, a longitudinal direction of the insertion portion being along a radial direction of the stator core.

According to the above-described aspects (1) and (6), during an operation of the rotary electric machine, an electromagnetic excitation force that causes the stator core to expand and contract in the radial direction is generated in the stator core. Then, the stator core is displaced in the radial direction with respect to the fastening member and the case within a range of a gap between the fastening member and an inner surface of the insertion portion in the insertion portion. Thereby, radial displacement of the stator core with respect to the fastening member and the case in accordance with expansion and contraction deformation of the stator core is allowed. Accordingly, vibration of the stator core transmitted directly from the stator core to the case or indirectly from the stator core to the case via the fastening member is suppressed. As a result, vibration of the rotary electric machine transmitted, for example, to a passenger compartment or the like as noise can be suppressed.

Moreover, since there is no change in a position of the insertion portion, an attachment position between the stator core and the case, or the like in the stator core, occurrence of noise can be suppressed with a relatively simple configuration.

According to the above-described aspect (2), by interposing a dowel in the insertion portion and in the attachment hole, positioning of the stator in the circumferential direction with respect to the fastening member and the case can be performed with high accuracy. Therefore, movement of the stator in the circumferential direction due to a motor torque or the like can be restricted.

According to the above-described aspect (3), in accordance with displacement of the stator core, the receiver allows radial displacement of the stator core. Thereby, vibration of the stator core transmitted directly to the case or indirectly to the case via the fastening member can be reliably suppressed.

According to the above-described aspect (4), even when the insertion portion having a longitudinal direction in the radial direction is formed, an axial load acting on the fastening member, the case and the stator core can be supported.

According to the above-described aspect (5), radial displacement of the stator core with respect to the fastening member and the case can be more reliably allowed while the axial load acting on the fastening member, the case, and the stator core is supported.

### BRIEF DESCRIPTION OF THE DRAWINGS

FIG. 1 is a schematic configuration view (cross-sectional view) of a rotary electric machine according to an embodiment.

FIG. 2 is a cross-sectional view corresponding to line II-II of FIG. 1.

FIG. 3 is a cross-sectional view corresponding to line of FIG. 2.

FIG. 4 is a cross-sectional view corresponding to FIG. 3 in a stator according to a modified example of the embodiment.

FIG. 5 is a cross-sectional view corresponding to FIG. 3 in a stator according to a modified example of the embodiment.

FIG. 6 is a cross-sectional view of a stator according to a modified example of the embodiment.

FIG. 7 is a cross-sectional view of a stator according to a modified example of the embodiment.

### DETAILED DESCRIPTION OF THE INVENTION

Hereinafter, an embodiment of the present invention will be described on the basis of the drawings.

### [Rotary Electric Machine]

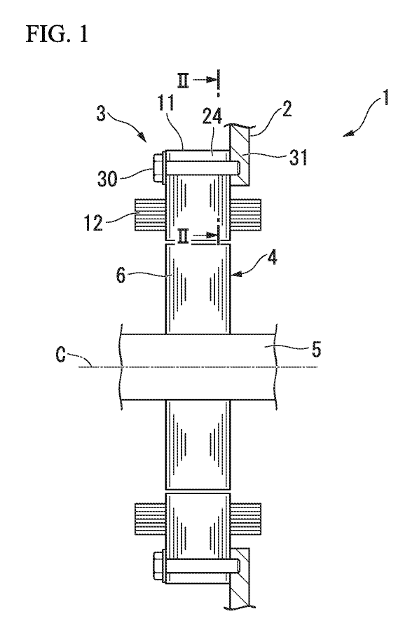

FIG. 1 is a schematic configuration view (cross-sectional view) illustrating an overall configuration of a rotary electric machine 1 according to an embodiment.

The rotary electric machine 1 illustrated in FIG. 1 is a traveling motor mounted, for example, on a vehicle such as a hybrid automobile or an electric automobile. However, a configuration of the present invention is applicable not only to traveling motors, but also to power generation motors, motors for other applications, or rotary electric machines (including generators) other than a vehicle application.

The rotary electric machine 1 includes a case 2, a stator 3, a rotor 4, and an output shaft 5.

The output shaft 5 is rotatably supported by the case 2.

The rotor 4 includes a rotor core 6 and a magnet (not illustrated) attached to the rotor core 6. The rotor core 6 is formed in a cylindrical shape externally fitted to the output shaft 5. In the following description, a direction along an axis C of the output shaft 5 is simply referred to as an axial direction, a direction perpendicular to the axis C is referred to as a radial direction, and a direction around the axis C is referred to as a circumferential direction in some cases.

<Stator>

The stator 3 includes a stator core 11 and a coil 12 attached to the stator core 11.

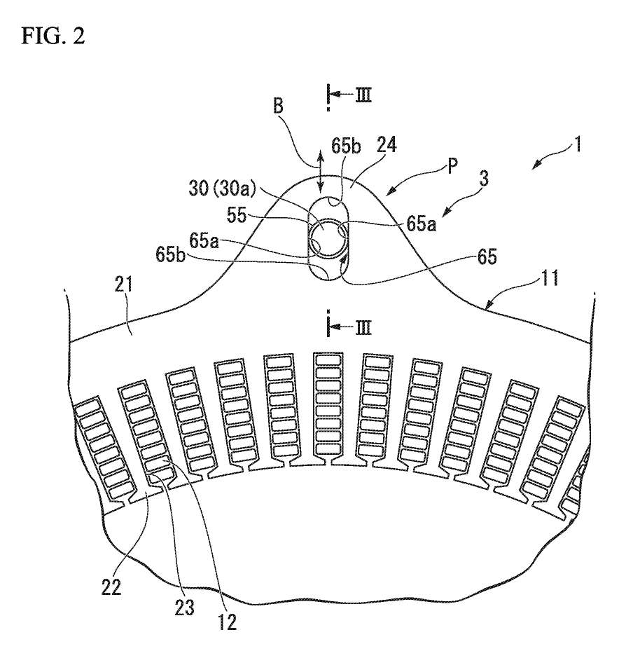

FIG. 2 is a partial plan view of the stator 3.

As illustrated in FIG. 2, the stator core 11 is formed in a cylindrical shape that surrounds the rotor 4 from the outside in the radial direction. The stator core 11 is configured by stacking annular plates formed by applying a punching process or the like on electromagnetic steel sheets in the axial direction. Further, the stator core 11 may be a so-called dust core.

The stator core 11 includes a back yoke portion 21 and a plurality of teeth portions 22.

The back yoke portion 21 is formed in a cylindrical shape disposed coaxially with the axis C. An attachment piece 24 protruding outward in the radial direction is formed on the outer circumferential surface of the back yoke portion 21. The attachment piece 24 is fixed to the case 2 via a bolt 30. A plurality of attachment pieces 24 are formed at intervals in the circumferential direction. In the present embodiment, for example, six attachment pieces 24 are formed at intervals of 60°. However, the number, positions, or the like of the attachment pieces 24 can be appropriately changed.

Each of the teeth portions 22 protrudes toward an inner side in the radial direction from an inner circumferential surface of the back yoke portion 21.

The plurality of the teeth portions 22 are formed at intervals in the circumferential direction. A slot 23 through which the coil 12 is inserted is formed between adjacent teeth 22 in the circumferential direction. The slot 23 penetrates the stator core 11 in the axial direction.

The coil 12 is mounted on the stator core 11 in a state in which a portion thereof is accommodated in the slot 23 of the stator core 11. The coil 12 includes a U-phase coil, a V-phase coil and a W-phase coil disposed with a phase difference of 120° with respect to each other in the circumferential direction.

As illustrated in FIG. 1, the case 2 accommodates the stator 3 and the rotor 4 in a state in which the output shaft 5 is rotatably supported. In the case 2, a base portion 31 for supporting the above-described attachment piece 24 is formed at a position facing the attachment piece 24 of the stator core 11 in the axial direction.

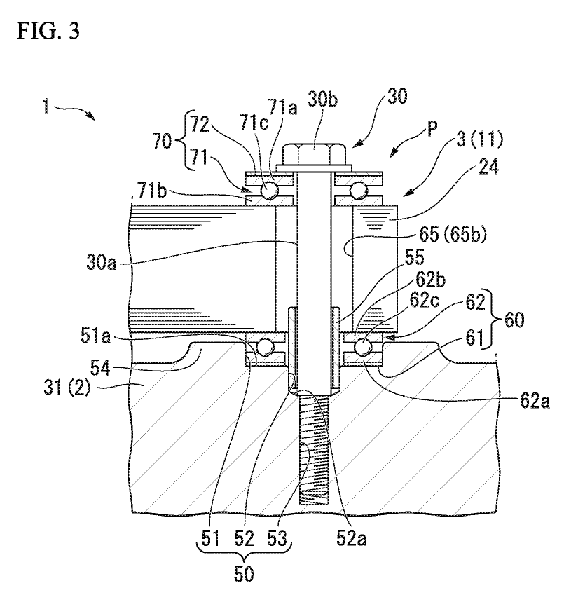

FIG. 3 is a cross-sectional view corresponding to line of FIG. 2.

Next, an attachment structure P of the case 2 (base portion 31) and the stator 3 (attachment piece 24) will be described in detail. In each of the attachment pieces 24, the attachment structures P have the same configuration as each other. Therefore, in the following description, the attachment structure P of one attachment piece 24 and the base portion 31 will be described as an example.

In the following description, in the axial direction, a direction from the stator 3 toward the base portion 31 will be described as toward a first side, and a direction from the base portion 31 toward the stator 3 will be described as toward a second side.

As illustrated in FIG. 3, an attachment hole 50 is formed in the base portion 31. The attachment hole 50 extends in the axial direction and is open toward the second side in the axial direction. The attachment hole 50 has a multi-stepped shape with a smaller inner diameter toward the first side in the axial direction. Specifically, the attachment hole 50 is formed to connect a large-diameter portion 51, an intermediate-diameter portion 52, and a small-diameter portion 53. A female screw portion to which the bolt (fastening member) 30 is screwed is formed on an inner circumferential surface of the small-diameter portion 53. Further, a boss portion 54 that bulges toward the second side in the axial direction is formed in a portion of the base portion 31 that is positioned around the attachment hole 50. The boss portion 54 surrounds a periphery of the attachment hole 50.

A dowel 55 is inserted into the intermediate-diameter portion 52. The dowel 55 is formed in a cylindrical shape extending in the axial direction. The dowel 55 is for performing positioning of the stator 3 in the circumferential direction with respect to the case 2. The dowel 55 is inserted into the intermediate-diameter portion 52 with a second side end portion thereof in the axial direction protruding from the attachment hole 50. A first side end surface in the axial direction of the dowel 55 is in close proximity to or in contact with a first connecting surface 52a connecting the intermediate-diameter portion 52 and the small-diameter portion 53 from the second side in the axial direction in the intermediate-diameter portion 52. Further, an inner diameter of the dowel 55 is set to be equal to or larger than an inner diameter of the small-diameter portion 53.

Inside the large-diameter portion 51, a first receiver 60 is disposed. The first receiver 60 supports a fastening force (axial force) acting in the axial direction between the stator 3 and the base portion 31 and allows radial displacement of the stator 3 with respect to the base portion 31 and the bolt 30 in accordance with expanding and contracting deformation of the stator 3. Specifically, the first receiver 60 includes a first washer 61 and a first bearing 62.

The first washer 61 is disposed coaxially with the attachment hole 50. The first washer 61 is disposed in the large-diameter portion 51 in a state of being externally fitted to the dowel 55. Specifically, in the large-diameter portion 51, the first washer 61 is in contact with the second connecting surface 51a connecting the large-diameter portion 51 and the intermediate-diameter portion 52 from the second side in the axial direction. Further, in the present embodiment, the first washer 61 may be made of a metal, for example.

In the large-diameter portion 51, the first bearing 62 is accommodated in a portion positioned on the second side in the axial direction with respect to the first washer 61. The first bearing 62 may be, for example, a thrust bearing. That is, the first bearing 62 has a configuration in which a rolling element 62c is held between a track plate 62a and the retainer 62b. The first bearing 62 is accommodated in the large-diameter portion 51 in a state in which the second side end portion thereof in the axial direction protrudes from the attachment hole 50 (the boss portion 54).

Here, an insertion portion 65 penetrating the attachment piece 24 in the axial direction is formed in the attachment piece 24. As illustrated in FIG. 2, the insertion portion 65 is formed in an elliptical shape in which the radial direction is a longitudinal direction.

That is, the insertion portion 65 is defined by a pair of guide surfaces 65a extending parallel to each other in the radial direction, and a connection surface 65b connecting outer end portions in the radial direction of the respective guide surfaces 65a and inner end portions in the radial direction of the respective guide surfaces 65a. In the present embodiment, the guide surfaces 65a are formed as flat surfaces facing each other in the circumferential direction and extending parallel to each other in the radial direction. On the other hand, a shape of the connection surface 65b in a plan view has a curved surface that is convex in the radial direction. However, a shape of the insertion portion 65 in a plan view may be, for example, a rectangle, an ellipse, or the like as long as it has a configuration in which a radial direction is a longitudinal direction.

As illustrated in FIG. 3, the attachment piece 24 is in contact with the first bearing 62 from the second side in the axial direction.

At this time, a gap is provided in the axial direction between the attachment piece 24 and the boss portion 54. In a state in which the attachment piece 24 is in contact with the first bearing 62, the second side end portion in the axial direction of the dowel 55 enters the insertion portion 65. That is, the dowel 55 is disposed over the inside of the attachment hole 50 and the inside of the insertion portion 65. In an outer circumferential surface of the dowel 55, a portion facing in the circumferential direction is in close proximity to or in contact with the guide surface 65a in the circumferential direction, and a portion facing in the radial direction is disposed in the insertion portion 65 in a state of being separated from the connection surface 65b in the radial direction. In the illustrated example (when the rotary electric machine 1 is not in operation), the dowel 55 is disposed in a center portion of the insertion portion 65 in the radial direction. Further, the dowel 55 may be disposed over the entire insertion portion 65 in the axial direction.

A second receiver 70 is disposed at a portion of the attachment piece 24 positioned on the second side in the axial direction. The second receiver 70 supports a fastening force (axial force) acting in the axial direction between the stator 3 and a head portion 30b of the bolt 30 and allows radial displacement of the stator 3 with respect to the base portion 31 and the bolt 30 in accordance with expanding and contracting deformation of the stator 3. Specifically, the second receiver 70 includes a second bearing 71 and a second washer 72.

The second bearing 71 has the same configuration as that of the above-described first bearing 62. That is, the second bearing 71 has a rolling element 71c held between a track plate 71a and a retainer 71b.

The second washer 72 is disposed on the second side in the axial direction with respect to the second bearing 71. The second washer 72 is disposed coaxially with the second bearing 71.

The bolt 30 is screwed into the small-diameter portion 53 of the attachment hole 50 through the insertion portion 65 of the attachment piece 24. Specifically, an inner diameter of a shaft portion 30a of the bolt 30 is smaller than a width in the circumferential direction of the insertion portion 65 and the inner diameter of the dowel 55. The shaft portion 30a passes through the inside of the second washer 72 and the second bearing 71, enters the insertion portion 65, and is then inserted into the dowel 55. A first side end portion in the axial direction of the shaft portion 30a protrudes from the dowel 55 and is screwed into the small-diameter portion 53.

The head portion 30b of the bolt 30 is in contact with the second washer 72 from the second side in the axial direction. As a result, the attachment piece 24 is fixed to the base portion 31 in the axial direction with the first receiver 60 sandwiched between the attachment piece 24 and the base portion 31 and the second receiver 70 sandwiched between the head portion 30b and the attachment piece 24.

<Operation>

Next, as an operation of the rotary electric machine 1 described above, an operation at the time of generating vibration in a circular zero-order mode will be described.

As illustrated in FIGS. 2 and 3, during the operation of the rotary electric machine 1, an electromagnetic excitation force that causes the stator core 11 to expand and contract in the radial direction is generated in the stator core 11. Then, the stator core 11 is displaced in the radial direction with respect to the bolt 30 and the base portion 31 within a range of a gap between the connection surface 65b and the shaft portion 30a of the bolt 30 in the insertion portion 65 (arrow B in FIG. 2). In accordance with displacement of the stator core 11, the first receiver 60 (mainly the first bearing 62) allows radial displacement of the stator core 11 between the base portion 31 and the attachment piece 24, and the second receiver 70 (mainly the second bearing 71) allows radial displacement of the stator core 11 between the attachment piece 24 and the head portion 30b. Thereby, vibration of the stator core 11 transmitted to the case 2 directly from the attachment piece 24 to the base portion 31 or indirectly from the attachment piece 24 to the base portion 31 via the bolt 30 is suppressed.

In the process of the displacement of the stator core 11 in the radial direction, the guide surface 65a of the insertion portion 65 is in sliding contact with the outer circumferential surface of the dowel 55. However, since the dowel 55 is in contact with the guide surface 65a in a direction (circumferential direction) perpendicular to a vibration direction (radial direction) of the stator core 11, transmission of the vibration due to a circular zero-order mode to the base portion 31 via the dowel 55 is suppressed. Further, when the attachment pieces 24 are provided at regular intervals in the circumferential direction as in the present embodiment, the stator core 11 tends to be uniformly deformed over the entire circumference. Thereby, even when the stator core 11 is deformed, a degree of coaxiality of the stator core 11 with respect to the axis C can be maintained. In the present embodiment, generation of the vibration in the circular zero-order mode has been mainly described, but since the stator core 11 is uniformly deformed over the entire circumference, a degree of coaxiality of the stator core 11 is maintained even in a deformation mode other than the circular zero-order.

As described above, in the present embodiment, the insertion portion 65 is configured to penetrate in the axial direction and extend in the radial direction in the attachment piece 24 of the stator core 11.

According to this configuration, radial displacement of the stator core 11 with respect to the bolt 30 and the case 2 in accordance with expanding and contracting deformation of the stator core 11 is allowed. Thereby, vibration of the stator core 11 transmitted to the case 2 directly from the attachment piece 24 to the base portion 31 or indirectly from the attachment piece 24 to the base portion 31 via the bolt 30 is suppressed. As a result, vibration of the rotary electric machine 1 transmitted, for example, to a passenger compartment or the like as noise can be suppressed.

Moreover, since there is no change in a position of the attachment piece 24, an attachment position between the attachment piece 24 and the base portion 31, or the like in the present embodiment, occurrence of noise accompanying vibration in a circular zero-order mode can be suppressed with a relatively simple configuration.

In the present embodiment, the dowel 55 disposed over the inside of the insertion portion 65 and the inside of the attachment hole 50 and having the bolt 30 inserted therein is configured to be provided.

According to this configuration, by interposing the dowel 55 in the insertion portion 65 and in the attachment hole 50, positioning of the stator 3 in the circumferential direction with respect to the bolt 30 and the base portion 31 can be performed with high accuracy. Therefore, movement of the stator 3 in the circumferential direction due to a motor torque or the like can be restricted.

In the present embodiment, the receivers 60 and 70 which support an axial load and allow radial displacement of the stator core 11 with respect to the bolt 30 and the base portion 31 are configured to be provided at least in a space between the head portion 30b of the bolt 30 and the attachment piece 24 and a space between the attachment piece 24 and the base portion 31.

According to this configuration, in accordance with displacement of the stator core 11, the first receiver 60 allows radial displacement of the stator core 11 between the base portion 31 and the attachment piece 24, and the second receiver 70 allows radial displacement of the stator core 11 between the attachment piece 24 and the head portion 30b. Thereby, vibration of the stator core 11 transmitted to the case 2 directly from the attachment piece 24 to the base portion 31 or indirectly from the attachment piece 24 to the base portion 31 via the bolt 30 can be reliably suppressed.

In the present embodiment, the bearings 62 and 71 are configured to be used respectively in the receivers 60 and 70.

According to this configuration, radial displacement of the stator core 11 with respect to the bolt 30 and the base portion 31 can be more reliably allowed while an axial load acting on the bolt 30, the base portion 31, and the stator core 11 is supported.

In the present embodiment, the washers 61 and 72 are configured to be used respectively in the receivers 60 and 70.

According to this configuration, even when the insertion portion 65 is formed in an oval shape, the axial load acting on the bolt 30, the base portion 31, and the stator core 11 can be supported.

### MODIFIED EXAMPLES

Next, a modified example of the above-described embodiment will be described.

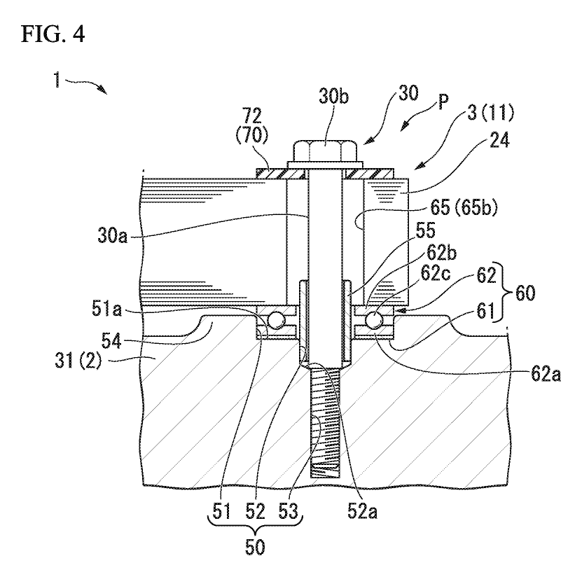

In the above-described embodiment, a configuration in which the washers 61 and 72 and the bearings 62 and 71 are respectively interposed between the head portion 30b of the bolt 30 and the attachment piece 24 and between the attachment piece 24 and the base portion 31 has been described, but the present invention is not limited only to this configuration. For example, as illustrated in FIG. 4, among spaces between the head portion 30b of the bolt 30 and the attachment piece 24 and between the attachment piece 24 and the base portion 31, the first washer 61 and the first bearing 62 may be interposed in one space and only the second washer 72 may be interposed in the other space. When only the second washer 72 is interposed, it is preferable to select an elastically deformable material (for example, a material made of a resin) for the second washer 72. As a result, the second washer 72 is elastically deformed with respect to the radial displacement of the stator core 11, and thereby vibration of the stator core 11 can be attenuated.

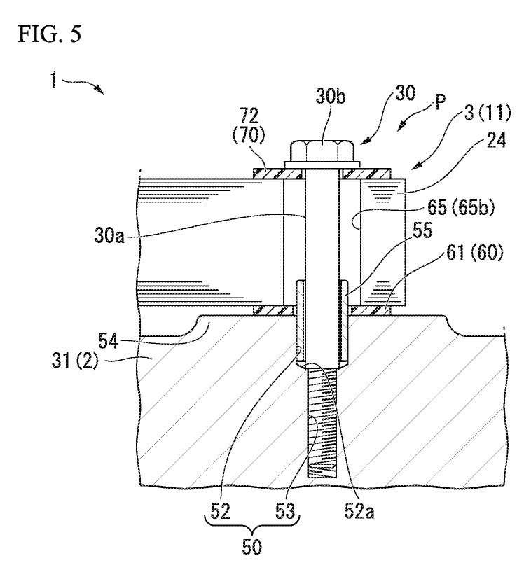

As illustrated in FIG. 5, the washers 61 and 72 made of a resin may be interposed between the head portion 30b of the bolt 30 and the attachment piece 24 and between the attachment piece 24 and the base portion 31.

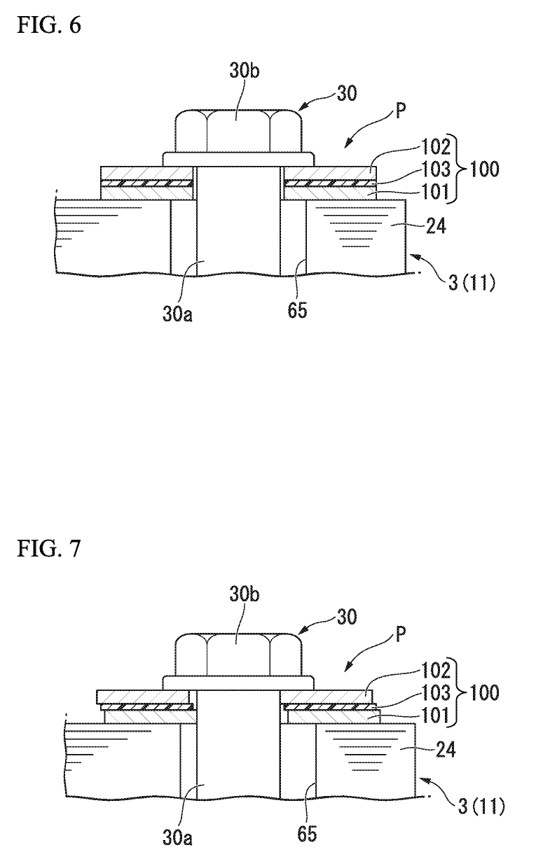

For example, as illustrated in FIG. 6, a configuration in which a resin washer 103 is interposed between metal washers 101 and 102 may be used for a receiver 100. For the resin washer 103, for example, polytetrafluoroethylene (PTFE) or the like is preferably used as a material having a lower frictional coefficient than the metal washers 101 and 102.

According to this configuration, as illustrated in FIG. 7, when the stator core 11 attempts to be displaced in the radial direction, the metal washers 101 and 102 slide in the radial direction relative to the resin washer 103. As a result, radial displacement of the stator core 11 is allowed. Moreover, since the resin washer 103 is sandwiched between the metal washers 101 and 102, the axial load acting on the bolt 30, the base portion 31, and the stator core 11 can be supported.

While preferred embodiments of the invention have been described and illustrated above, it should be understood that these are exemplary of the invention and are not to be considered as limiting. Additions, omissions, substitutions, and other modifications can be made without departing from the spirit or scope of the present invention.

For example, in the above-described embodiment, the configuration in which the receivers 60 and 70 are respectively interposed between the head portion 30b of the bolt 30 and the attachment piece 24 and between the attachment piece 24 and the base portion 31 has been described, but a configuration not having the receivers 60 and 70 may be used.

In the above-described embodiment, the configuration in which the dowel 55 is disposed over the inside of the insertion portion 65 and the inside of the attachment hole 50 has been described, but the configuration is not limited to this configuration. For example, by using a stepped bolt or the like for the bolt 30, positioning of the stator core 11 in the circumferential direction with respect to the base portion 31 may be performed using the bolt 30.

In the above-described embodiment, the case in which the bolt 30 is employed as a fastening member has been described, but the present invention is not limited to this configuration.

In addition, the components in the above-described embodiments can be appropriately replaced with well-known components without departing from the spirit and scope of the present invention, and furthermore, the above-described modified examples may be appropriately combined.

What is claimed is:

1. A rotary electric machine comprising:
a cylindrical stator core on which a coil is mounted; and
a case to which the stator core is fastened via a fastening member, wherein
an insertion portion which penetrates the stator core in an axial direction of the stator core and through which the fastening member is inserted is formed in the stator core, a longitudinal direction of the insertion portion being along a radial direction of the stator core.

2. The rotary electric machine according to claim 1, wherein
an attachment hole to which the fastening member is fastened is formed in the case, and
a dowel which is disposed inside the insertion portion and the attachment hole and in which the fastening member is inserted is provided.

3. The rotary electric machine according to claim 1, wherein
the fastening member is a bolt, and
a receiver which supports an axial load and allows radial displacement of the stator core with respect to the fastening member and the case is interposed in at least one of a space between a head portion of the fastening member and the stator core and a space between the stator core and the case in the axial direction.

4. The rotary electric machine according to claim 3, wherein the receiver includes a washer.

5. The rotary electric machine according to claim 3, wherein the receiver includes a thrust bearing.

6. A stator comprising:
a cylindrical stator core on which a coil is mounted, wherein
an insertion portion through which a fastening member that fastens the stator core to a case is formed in the stator core, and
the insertion portion penetrates the stator core in an axial direction of the stator core, a longitudinal direction of the insertion portion being along a radial direction of the stator core.
